(19) United States
(12) Patent Application Publication
(10) Pub. No.: US 2008/0260916 A1
(43) Pub. Date: Oct. 23, 2008

(54) Method for Treating Foodstuffs, Particularly for Preserving Fresh Sausage or Meat Products

(76) Inventor: Fritz Kortschack, Berlin (DE)

Correspondence Address: BODNER & O'ROURKE, LLP, 425 BROADHOLLOW ROAD, SUITE 108, MELVILLE, NY, 11747, US

(21) Appl. No.: 11/886,190

(22) PCT Filed: Mar. 10, 2006
(86) PCT No.: PCT/EP2006/002240

§ 371 Date: Jun. 19, 2008

(30) Foreign Application Priority Data
Mar. 15, 2005 (DE) 10 2005 011 868.2

(51) Int. Cl. A23B 4/00; A23B 4/005; A23L 1/317; A23L 3/015

(52) U.S. Cl. 426/105

(57) ABSTRACT

The invention relates to method for the treatment of foodstuffs, especially for preserving fresh sausage or meat products, by means of a time-limited temperature and/or pressure or high-pressure influence, and for placing the product on the market thereafter, wherein the already packed product is subjected to the treatment step and a film having expandable properties, a remaining or permanent elasticity is used at least for parts of the packaging material.

The invention relates to a method for the treatment of foodstuffs, especially for preserving fresh sausage or meat products, by means of a time-limited temperature and/or pressure or high-pressure influence.

A method for the treatment of meat is already known from DE 102 45 603 A1, which specifically relates to a so-called warm meat cutting. After the bones have been removed from the bodies of the beef cattle in a warm state and upon cutting the boned bodies of the beef cattle into portioned units, the portioned units are packed, and said packed units are subjected to cooling under defined conditions. According to this invention, the packing of the portioned units is achieved by applying an external pressure, specifically a fluid pressure, by means of a film or a membrane in such a way that the portioned units are each tightly enclosed, if possible, without entrapped air.

The desired packing, wherein the portioned units are each tightly and adjacently enclosed by the wrapping material, is realized by placing a portioned unit onto a film and covering it with another film. The outside of the first lower film is supplied with the aforementioned fluid pressure so as to fit tightly and without the formation of wrinkles around the material to be wrapped, if necessary, after air has been pumped out of a film gap in advance. The active external fluid pressure makes the upper film and the lower film move towards each other and welds them together as soon as the films are in contact. The built-up of the fluid pressure can be realized by pressing the films together with the meat located between the films into a fluid by means of a lowering device until the upper and the lower film are in contact. To stop the packing process, the sealing is performed by the aforementioned welding. The used films are either sufficiently flexible at the treatment temperature, or they are slightly heated by the fluid so as to make them fit tightly around the meat. The tight fit of the films can be improved by using materials that shrink under the influence of heat.

A packing method for warm slaughter meat is known from Meat Magazine No. 9/2002, page 42 et seq., wherein a permanently elastic tubular film from a supply reel on the packing machine is fed through a packing pipe from the backside. On the front opening of the packing pipe the tubular film is opened by grip hooks up to the edge of the packing pipe. Then, a negative pressure is produced in the packing tube, and the piece of meat is held in front of the opening.

Despite its sticky surface the piece of meat is sucked by the negative pressure into the packing tube, thereby expanding the circumference thereof. Once the piece of meat has reached the correct position the negative pressure is turned off. The elastic packing is automatically restored and tightly encloses the piece of meat. The so packed piece of meat can then be removed from the packing pipe. The open ends of the package are sealed in a separate sealing device.

The above-described packing method used in the warm meat production allows an advantageous packing and creates an optically attractive product.

Moreover, it is known to preserve meat and sausage products by means of a high-pressure treatment, wherein, for production-technological and economic reasons, the high-pressure treatment is carried out inside the sales packaging, if possible. However, it has shown, for example, when subjecting sausages placed in a package to a high-pressure treatment, that the treatment in the high-pressure plant subjects the packing material during the pressure treatment to forces that may result in kinks, so that eventually moisture and also germs can enter.

Based on the foregoing the invention is based on the object to provide an advanced method for the treatment of foodstuffs, especially for preserving fresh sausage or meat products, by means of a time-limited temperature and/or pressure or high-pressure influence, as well as for placing the product on the market thereafter, wherein the treatment is carried out in the sales packaging, e.g. a can or tray, namely without damaging the packaging during the preservation treatment, which damages would otherwise prevent the placing on the market or require repackaging.

The object of the invention is achieved with a method as defined in patent claim 1, wherein the dependent claims represent at least useful embodiments and advancements.

According to the inventive method for the treatment of foodstuffs, especially for preserving fresh sausage or meat products, by means of a time-limited temperature and/or pressure or high-pressure influence, and for placing the product on the market thereafter the already packed product is subjected to the treatment step, wherein a film having expandable properties, a remaining or permanent elasticity is used for parts of the packaging material.

The pressure treatment brings the film into contact and compresses the material enclosed by the film, with the consequence that a subsequent or simultaneous heat or cooling treatment is less energy-intensive or performable in less time due to an optimized heat conductivity.

The high-pressure treatment can be performed simultaneously with a thermal treatment.

In an embodiment of the invention the sales packaging comprises rigid or semi-rigid parts, wherein the sealing of the packaging is achieved with the aforementioned elastic film which is subjected to an expansion under the pressure treatment and then returns substantially to its original shape.

If a can or a tray are used as packaging, the film is used as top closure.

The thickness and the stability of the rigid part of the packaging material are selected to avoid a deformation of this part during the pressure or high-pressure treatment.

By means of the above-explained method fresh, cooled meat or corresponding sausage products can be offered in a technologically optimized manner, so that the requirements of the market are satisfied. Because of the preservation directly inside the sales packaging, and by consequently observing the cold chain thereafter, the consumer can be offered, in connection with the packaging quality, an optically very attractive product.

It is in accordance with the invention that the packing of the sausage or meat products is performed under a protective atmosphere, wherein the type and the composition of the respective gas mixture are chosen in dependence on the water activity value and the risks and parameters of microbial loads.

When using the provided method for the transportation of fresh meat from the manufacturer to the consumer or bulk consumer it is possible to use reusable containers, e.g. of metal or a glass fiber-reinforced synthetic material, wherein these containers are coated with a correspondingly elastic film in an airtight manner on at least one side and are thereby sealed. Depending on the given cutting degree, these containers can receive small meat pieces, escalopes, steaks, cutlets etc. up to beef quarters or pork halves. According to an embodiment of the invention the containers can be filled with warm slaughter products to increase the quality and reduce losses, and can be cooled down under pressure for the purpose of compressing the existing insulating gas layer so as to obtain a better heat transfer. After the temperature control is terminated, the external pressure of the high-pressure or pressure treatment is eliminated so that the then decompressing protective atmosphere fills again the entire interior of the corresponding container.

The invention will be explained in more detail below by means of embodiments.

According to a first embodiment, fresh beef and also pork was cut in a warm state (>34° C.), portioned and placed in a prefabricated tray. The tray was covered in a packing machine with a flexible film, evacuated and re-gassed with a gas mixture. Subsequent to the gassing the peripheral edges of the tray were welded together with the upper film, whereby it was ensured that the welding seams could cool down sufficiently so as to obtain a permanent connection of the synthetic materials. These fresh meat packages were given into a pressure vessel filled with water and were cooled down at a pressure of approximately 3 bar to 15° C. Upon the occurrence of the “rigor mortis” in the meat the packages were cooled to 2° C. by exchanging the still pressurized water.

The applied pressure of approximately 3 bar was sufficient to compress the gas mixture to such an extent that the expanded top film and the bottom area of the packaging tray were in direct contact with the product being treated (beef or pork) and a good heat transfer from the warm meat (>34° C.) to the cooling medium (water of initially 15° C. and 2° C. later on) was achieved.

After the pressure in the pressure vessel had been reduced it was found that the flexible top film returned to its initial shape. Externally, no difference as compared to a conventionally produced meat package was detected.

The so produced packages could be offered for sale without any problems, wherein the advantages obtained by cutting and packing warm meat had been realized.

Another example proves that the high-pressure treatment (6000 bar) of finished self-service packages (gassed ham in slices) allows the destruction of undesired germs. Certain package geometries (large volumes) could, however, not be subjected to high-pressure because the relatively rigid films showed kinks after the high-pressure treatment, which lead to a “leakage”. For this film, the top film of known self-service packages was replaced by a flexible film as a result of which no more leakages occurred because only the flexible film was expanded under the pressure and returned to its original shape once the pressure was eliminated.

A supplementary example proves that filled self-service packages can be pasteurized under pressure. Frying sausages packed into gassed trays were heated in an autoclave at >3 bar to 72° C. and were held under this pressure at a constant temperature for about 15 minutes. The packages were then cooled down to approximately 35° C. still under a pressure of >3 bar and removed from the autoclave.

The inflated packages (the gas bulged the top film and the walls of the deep-drawn package toward the outside) were cooled down further to approximately 7° C. in a cooling room, wherein the gas volume shrunk and the packages could no longer be distinguished from conventionally produced self-service packages. Due to the possibility to pasteurize also gassed packages the clean room technology during the packing process for increasing the product stability is dispensable.

1. Method for the treatment of foodstuffs, especially for preserving fresh sausage or meat products, by means of a time-limited temperature and/or pressure or high-pressure influence, and for placing the product on the market thereafter, wherein the already packed product is subjected to the treatment step and a film having expandable properties, a remaining or permanent elasticity is used for parts of the packaging material.

2. Method according to claim 1,
characterized in that
the pressure treatment brings the film into contact and compresses the material enclosed by the film, with the consequence that a subsequent or simultaneous heat or cooling treatment is less energy-intensive or performable in less time due to an optimized heat conductivity.

3. Method according to claim 1 or 2,
characterized in that
the high-pressure or pressure treatment can be performed simultaneously with a thermal treatment.

4. Method according to one of the preceding claims,
characterized in that
the packaging comprises rigid or semi-rigid parts, wherein the sealing of the packaging is achieved with the elastic film which is subjected to an expansion under the pressure treatment and then returns substantially to its original shape.

5. Method according to claim 4,
characterized in that
the film is used as top closure or lid if a can or a tray are used as packaging.

6. Method according to one of the preceding claims,
characterized in that
the thickness and the stability of the rigid part of the packaging material are selected to avoid a deformation during the pressure or high-pressure treatment.
